(19) United States
(12) Patent Application Publication
(10) Pub. No.: US 2025/0356562 A1
(43) Pub. Date: Nov. 20, 2025

(54) GENERATING 3D ANIMATED IMAGES FROM 2D STATIC IMAGES

(71) Applicant: GOOGLE LLC, Mountain, CA (US)

(72) Inventors: Yuchen Zhang, Jersey City, NJ (US); Xiaohang Li, Mountain View, CA (US); Michael Krainin, Arlington, MA (US); Dongdong Wang, Sunnyvale, CA (US)

(21) Appl. No.: 18/666,049

(22) Filed: May 16, 2024

(51) Int. Cl. G06T 13/20; G06T 5/77; G06T 7/00; G06T 7/50; G06T 17/20; G06V 20/62

(52) U.S. Cl. CPC G06T 13/20; G06T 5/77; G06T 7/0002; G06T 7/50; G06T 17/20; G06V 20/62; G06T 2207/20081; G06T 2207/20084; G06T 2207/30168; G06T 2207/30241; G06T 2210/32; G06V 2201/09

(57) ABSTRACT

Systems and methods for converting two-dimensional (2D) static images to three-dimensional (3D) animated images are provided. Such a method includes: receiving, by a server device, one or more 2D static images, each 2D static image of the one or more 2D static images depicting a respective environment; generating a 3D mesh based on a 2D static image of the one or more 2D static images; determining a visual perspective trajectory along the 3D mesh, the visual perspective trajectory indicative of simulated movement within a 3D animated image at least partially along an axis associated with depth in the respective environment depicted by the 2D static image; and generating the 3D animated image based on the 3D mesh and the visual perspective trajectory such that the 3D animated image replicates the simulated movement.

### FIELD OF TECHNOLOGY

The present disclosure relates to image generation and, more specifically, to using and/or generating models that convert two-dimensional (2D) static images to three-dimensional (3D) animated images.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

In various use cases, video media are preferred over static images as appearing more vivid and realistic. For example, in digital advertising, advertisers may want to appeal to potential consumers by providing dynamic, sweeping imagery that properly depicts scope and depth of a locale or object. However, videos require significantly more memory to store and display than static images. In traditional systems, an advertiser may choose between using additional resources to generate, store, and provide a dynamic video (e.g., by using additional resources to convert pre-formatted templates for a static image to utilize video data) and losing the benefits of a more dynamic display.

Moreover, video media may require specialized templates or code to run and/or display to a user. As such, using video media with traditional image templates may cause errors, lead to large quantities of lag as data is transferred to and from a server device, and/or otherwise impact a user experience. As such, conventional techniques are insufficient for providing content to a user that provides the benefits of videos while also including benefits of image-based formats.

### SUMMARY

In one example implementation, a computer-implemented method for converting 2D static images to 3D animated images includes: (i) receiving, by one or more processors of a server device, one or more 2D static images, each 2D static image of the one or more 2D static images depicting a respective environment; (ii) generating, by the one or more processors, a 3D mesh based on a 2D static image of the one or more 2D static images; (iii) determining, by the one or more processors, a visual perspective trajectory along the 3D mesh, the visual perspective trajectory indicative of simulated movement within a 3D animated image along an axis associated with depth in the respective environment depicted by the 2D static image; and (iv) generating, by the one or more processors, the 3D animated image based on the 3D mesh and the visual perspective trajectory such that the 3D animated image replicates the simulated movement.

In another example implementation, a computing system includes one or more processors and a non-transitory, tangible computer-readable medium storing instructions. The instructions, when executed by the one or more processors, cause the computing system to: (i) receive one or more 2D static images, each 2D static image of the one or more 2D static images depicting a respective environment; (ii) generate a 3D mesh based on a 2D static image of the one or more 2D static images; (iii) determine a visual perspective trajectory along the 3D mesh, the visual perspective trajectory indicative of simulated movement within a 3D animated image along an axis associated with depth in the respective environment depicted by the 2D static image; and (iv) generate the 3D animated image based on the 3D mesh and the visual perspective trajectory such that the 3D animated image replicates the simulated movement.

### BRIEF DESCRIPTION OF THE DRAWINGS

FIG. 1A is a block diagram of an example system in which techniques for efficiently converting 2D static images to 3D animated images can be implemented.

FIG. 1B is a block diagram of an example system in which techniques for providing 3D animated images to a user device can be implemented.

FIG. 2 depicts an example block diagram for training and/or using a generative machine learning model.

FIG. 3A depicts an example initial input 2D static image to be converted into a 3D animated image.

FIG. 3B depicts an example depth map generated based on the initial input 2D static image of FIG. 3A.

FIG. 3C depicts an example 3D mesh generated based on the depth map and initial input 2D static image of FIGS. 3A and 3B.

FIG. 3D depicts an example 3D image generated by overlaying the 3D mesh with the initial input 2D static image of FIGS. 3A and 3C.

FIG. 3E depicts an example visual perspective trajectory generated for an output 3D animated image generated based on the 3D image of FIG. 3D.

FIG. 4 depicts an system with modules for converting a 2D static image into a 3D animated image to be implemented in a system such as that of FIG. 1A.

FIG. 5A depicts an example original image to be extended using a generative machine learning model such as that depicted in FIG. 2.

FIG. 5B depicts an example extended image generated using a generative machine learning model based on the original image depicted in FIG. 5A.

FIG. 6 is a flow diagram of an example method for converting a 2D static image into a 3D animated image.

### DETAILED DESCRIPTION OF THE DRAWINGS

Generally, implementations for generating a cinematic 3D image in an animated image format from a static 2D image may utilize a 3D mesh map of the static 2D image and a visual perspective trajectory generated to be representative of a simulated path of motion for a simulated camera. In particular, a server device may receive one or more 2D static images from a content provider or other entity and analyze the 2D static images using a trained machine learning algorithm to estimate depth of the image based on a determined disparity of various portions of the 2D static image. The server device may generate a 3D mesh map representative of the estimated depth for the 2D static image and determine a particular visual perspective trajectory through the 3D mesh map at least partially along an axis associated with depth in the environment of the 2D static image. The server device may then generate the cinematic (e.g., animated) 3D image.

As referred to herein, a “2D static image” can be any two-dimensional image stored as a static image (e.g., PNG format, JPEG format, TIFF format, PSD format, PDF format, etc.), unless otherwise made clear. Similarly, as referred to herein, a “3D animated image” can be an image that appears three-dimensional to a viewer (e.g., that gives the illusion of depth) and is stored in an animated non-video format (e.g., GIF format, AV1 Image File (AVIF) format, etc.), unless otherwise made clear. Conversely, as referred to herein, a “video” can be a series of images that are stored in a video format (e.g., MP4 format, MOV format, AVI format, WMV format, etc.) containing video data (and possibly also audio data), unless otherwise made clear. Further, a video can differ from a 3D animated image in terms of display requirements, formatting requirements, memory and/or storage requirements, etc. Moreover, while an animated non-video format may give an illusion of depth to a user (e.g., by moving at least partially along an axis associated with depth) using an image or images stored according to an image format, a video may include multiple images/frames, each having an actual different perspective and/or depth, and stored according to a video format.

By generating the cinematic 3D image in an animated image format and based on the 3D mesh map and the visual perspective trajectory, a server device may save processing power, memory, and other such resources while maintaining benefits (e.g., aesthetic benefits) provided by a video format. In particular, the 3D mesh map is generated and utilized to provide a sense of depth to a viewer that the server device may use in conjunction with the visual perspective trajectory. By generating, for example, the visual perspective trajectory such that the visual camera moves at least partially along an axis associated with depth, the viewer may be given the illusion of forward movement in a setting, creating a sense of scale and realism from the point of view of the viewer, without the storage and processing requirements of video media. Similarly, as the server device generates the cinematic 3D image in an (animated) image format, existing static image templates may be used rather than generating new templates for 3D or video media and/or heavily modifying the existing static image templates.

Further, the server device may perform a pre-processing step to filter out 2D static images that are excessively resource-intensive and/or otherwise poor candidates for 3D conversion. For example, the server device may use a trained image quality model to detect and discard 2D static images with qualities below a respective predetermined threshold value. Similarly, the server device may use an optical character recognition (OCR) model to detect and discard 2D static images with too much text for 3D conversion. As another example, the server device may detect and discard 2D static images with a logo and/or with insufficient depth information (e.g., an image with a cartoon and/or other such animation) using a logo detection model and/or a flat image detection module, respectively.

Moreover, the server device may detect that a 2D static image would be improved by extending the boundaries of the image (e.g., due to preferred aspect ratios, cropped salient objects, etc.). The server device may then generate an uncropped version of the image using a trained generative machine learning model to predict surrounding pixels. The server device may then perform the 3D conversion process as described herein on the newly uncropped 2D static image.

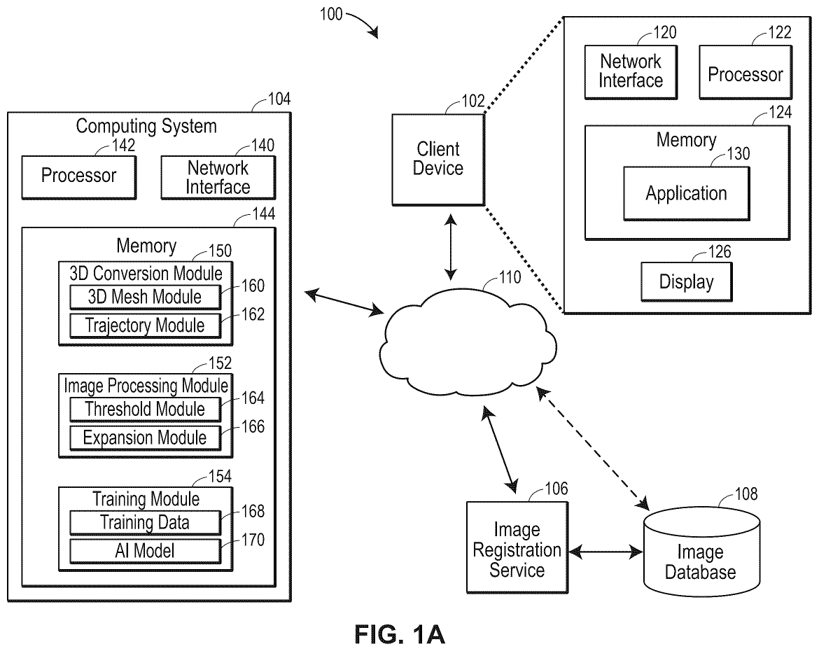

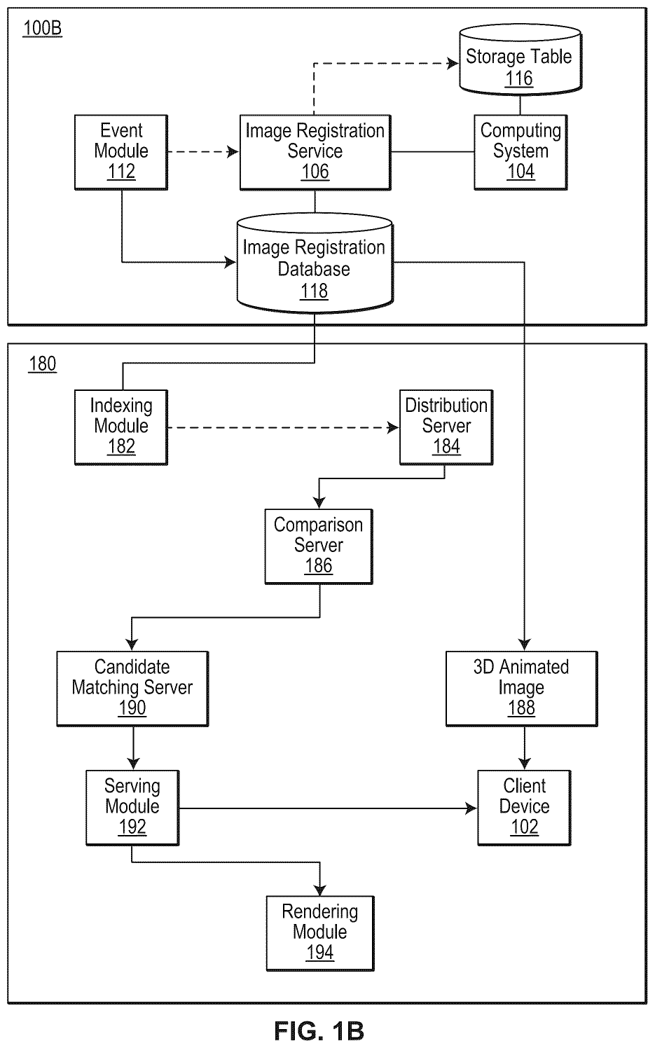

FIG. 1A illustrates an example system 100A in which one or more techniques for converting 2D static images to 3D animated images may be implemented. The example system 100A includes a client device 102, a computing system 104, an image registration service 106, an image database 108, and a network 110. The computing system 104 in some implementations is remote from the client device 102 and/or image database 108, as well as communicatively coupled to the client device 102 and/or image database 108 via the network 110. It will be understood that the example system 100A is exemplary, and that other systems may include additional, fewer, or alternative components (e.g., training module 154 may be omitted). Similarly, arrangements of the components of system 100A may be modified. For example, some elements of system 100A may be combined, split apart, swapped, etc.

The network 110 may be a single communication network (e.g., the Internet), and in some implementations also includes one or more additional networks. As an example, the network 110 may include a cellular network, the Internet, and a server-side local area network (LAN). While FIG. 1A shows only a single client device 102, image registration service 106, and image database 108, it will be understood that the system 100A may include any suitable number of similar client devices, publishers, and/or content sponsors operating according to the principles disclosed herein.

Generally, the client device 102 can access one or more images supplied or published by the computing system 104, and the computing system 104 converts a 2D static image into a 3D animated image to be served to the client device 102 via the image registration service 106 using 2D static images stored at the image database 108. In further implementations, the image database 108 is part of the computing system 104. Depending on the implementation, the computing system 104 may receive 2D images and output 2D and 3D images via the image registration service 106. In further implementations, the computing system 104 may include and/or additionally be communicatively coupled to a historical data server (e.g., storing training data 168) for use in training one or more machine learning (ML) and/or artificial intelligence (AI) models (e.g., machine learning model 170, referred to herein variously as “AI model 170”, “ML model 170”, and “AI and/or ML model 170”) as described herein.

In some implementations, the client device 102 additionally receives information resources from a publisher (not shown) or other entity. Depending on the implementation, the information resources may be web pages of a website hosted by the publisher, and the image database 108 may store image data to be served to the client device 102 for interactions associated with the information resources. Alternatively, the computing system 104 may include the image database 108 and/or store image data in addition to or in place of the image database 108. Depending on the implementation, a publisher may upload one or more 2D static images to the image registration service 106 and/or directly to the image database 108. In some such implementations, the publisher may indicate whether to attempt to convert the 2D static images to 3D animated images. In further implementations, the computing system 104, image registration service 106, and/or computing device associated with the image database 108 may determine that one or more uploaded 2D static images should be converted to 3D animated images automatically. In some such implementations, the computing system 104 and/or image registration service 106 stores the determined 2D static images in a serving stack and filters out images from publishers and/or other content providers that have indicated a preference to use 2D static images and/or refrained from indicating a preference to use the 3D animated image conversion process.

In some implementations, the image served to the user of the client device 102 may be an image on a website, application, etc. as provided by a publisher (not shown) or another entity to the client device 102 for installation, where the website/application/other page includes content slots that are to be populated (e.g., by computing system 104) with the images as served to the user. In some such implementations, the content slots are content slots that are to be populated with images (e.g., using image format templates), and therefore require a significant investment of resources to be modified to be populated video data. For example, a content slot configured to be populated with an image may be formatted (e.g., to utilize a template) according to an HTML script specific to images and/or image data. To modify the content slot to display video data would require additional HTML script for new front end designs using code formatting languages (e.g., cascade styling sheets (CSS)). Using an animated image format for 3D animated images, then, reduces the need for additional processing and resource usage to reformat content slots compared to video data while still providing the benefits of video data. In some implementations, the image format is an AVIF image format, which has smaller memory and/or network requirements than a GIF image format.

The client device 102 may be or include any stationary, mobile, or portable computing device with wired and/or wireless communication capability (e.g., a smartphone, a tablet computer, a laptop computer, a desktop computer, a smart wearable device such as smart glasses or a smart watch, a vehicle head unit computer, etc.). In the example implementation of FIG. 1A, the client device 102 includes a network interface 120, a processor 122, memory 124, and a display 126. The processor 122 may be a single processor (e.g., a central processing unit (CPU)), or may include a set of processors (e.g., multiple CPUs, or one or more CPUs and one or more graphics processing units (GPUs)).

The memory 124 includes one or more computer-readable, non-transitory storage units or devices, which may include persistent (e.g., hard disk) and/or non-persistent memory components. The memory 124 stores instructions that are executable by the processor 122 to perform various operations, including the instructions of various software applications and the data generated and/or used by such applications. In the example implementation of FIG. 1A, the memory 124 stores at least an application 130, which may be, for example, a web browser application, a mobile application downloaded from an application store, or a video player application.

Generally, the application 130 is executed by the processor 122 to present information resources and/or image data to the user of the client device 102 via the display 126 (and possibly one or more speakers of the client device 102, not shown in FIG. 1A). In further implementations, at least one of the information resources includes one or more spatial and/or temporal content slots for dynamically presenting 3D animated image content, 2D static image content, textual content, and/or any other such information resources. In an implementation where the application 130 is a web browser application, for instance, an information resource may be a web page hosted by a publisher, with the web browser causing the client device 102 to download HyperText Markup Language (HTML), scripts, and/or other code of the web page for presentation to a user via the display 126.

The display 126 includes hardware, firmware, and/or software configured to enable a user to view visual outputs of the client device 102, and may use any suitable display technology (e.g., LED, OLED, LCD, etc.). In some implementations, the display 126 is incorporated in a touchscreen having both display and manual input capabilities. Moreover, in some implementations where the client device 102 is a wearable device, the display 126 is a transparent viewing component (e.g., lenses of smart glasses) with integrated electronic components. For example, the display 126 may include micro-LED or OLED electronics embedded in lenses of smart glasses.

The network interface 120 includes hardware, firmware, and/or software configured to enable the client device 102 to exchange electronic data with the computing system 104 via the network 110. For example, the network interface 120 may include a cellular communication transceiver, a Wi-Fi transceiver, and/or transceivers for one or more other wired and/or wireless communication technologies.

While FIG. 1A shows client device 102 as a single component communicating directly (i.e., via network 110) with the computing system 104, in some implementations the subcomponents of client device 102 shown in FIG. 1A are instead divided among two or more user-side devices. As just one example, a pair of smart glasses may include the processor 122, the memory 124, and the display 126, while a smartphone may include another processing unit, another memory, another display, and the network interface 120. The smart glasses (or smart helmet, etc.) may then communicate as needed with the smartphone (e.g., via Bluetooth) to enable the operations described herein.

The computing system 104 includes a network interface 140, a processor 142, and memory 144. The network interface 140 includes hardware, firmware, and/or software configured to enable the computing system 104 to exchange electronic data with the client device 102 and other, similar client devices via the network 110. For example, the network interface 140 may include a wired or wireless router and a modem. The processor 142 may be a single processor, may include two or more processors, etc. The computing system 104 may include one or more servers, for example, which may reside at a single location or multiple locations.

The memory 144 is a computer-readable, non-transitory storage unit or device, or collection of units/devices, that may include persistent and/or non-persistent memory components. The memory 144 stores the instructions of a 3D conversion module 150, an image processing module 152, and a training module 154, each of which may be executed by the processor 142. The 3D conversion module 150 may include a 3D mesh module 160 and a trajectory module 162. The image processing module 152 may include a threshold module 164 and an expansion module 166. The training module 154 may store and/or receive training data 168 for training one or more machine learning models (e.g., machine learning model 170) as described herein. In some implementations, some of the software modules/units shown in FIG. 1A are omitted. For example, the image processing module 152 may omit the threshold module 164, or the training module 154 may be omitted in its entirety.

The 3D conversion module 150, image processing module 152, and training module 154 are software modules comprising instructions executed by the processor 142 to generate, convert, and/or otherwise facilitate the production of a 3D animated image using one or more 2D static images. In some implementations, the modules may additionally generate, train, and/or otherwise use a machine learning model 170 for performing the methods as described herein. For example, the computing system 104 may generate, train, and/or use an a machine learning model 170 to (i) perform an image extension operation on the 2D static image prior to converting the image to a 3D animated image, (ii) generate a 3D mesh, (iii) generate a visual perspective trajectory to give an illusion of motion to a viewer of the 3D animated image, (iv) filter out one or more 2D static images prior to 3D animated image conversion, and/or (v) otherwise perform operations as described herein.

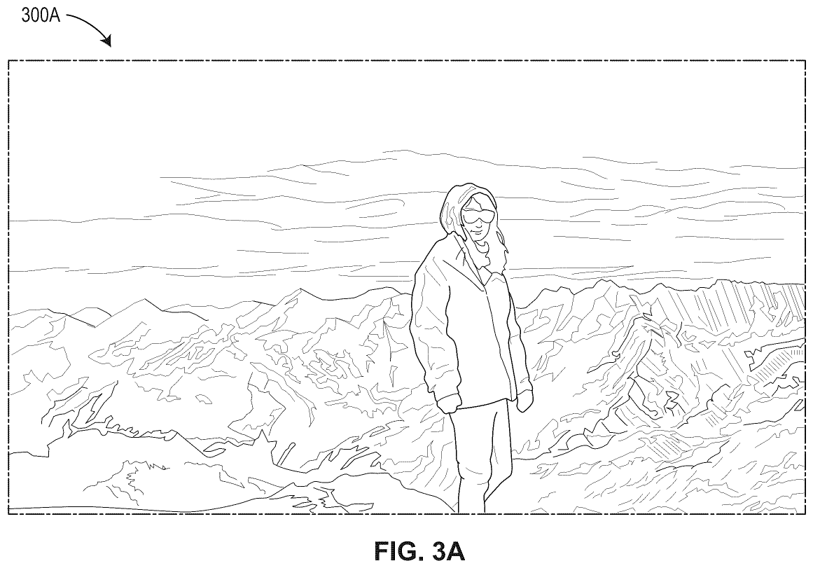

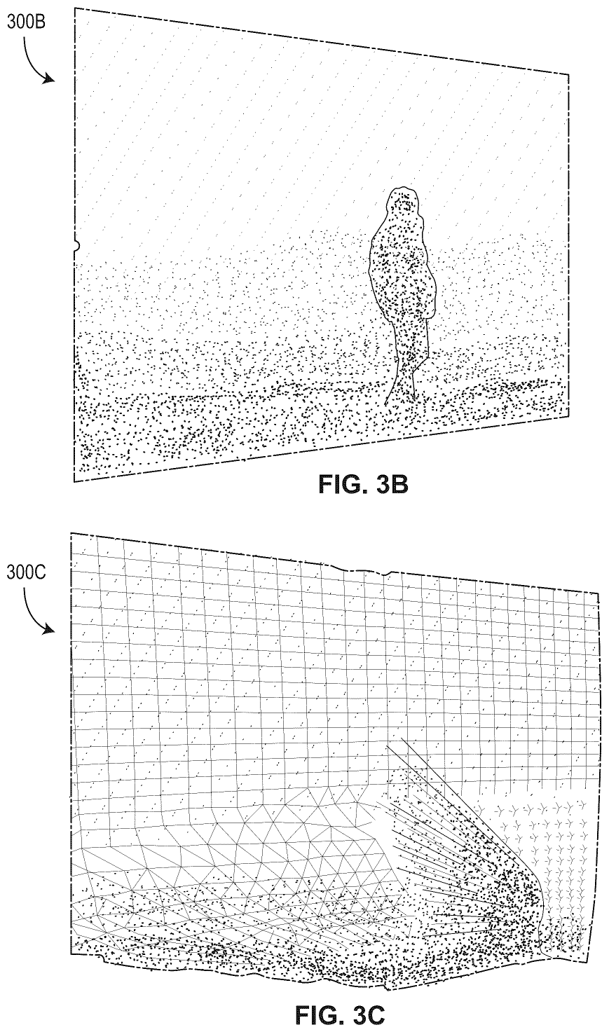

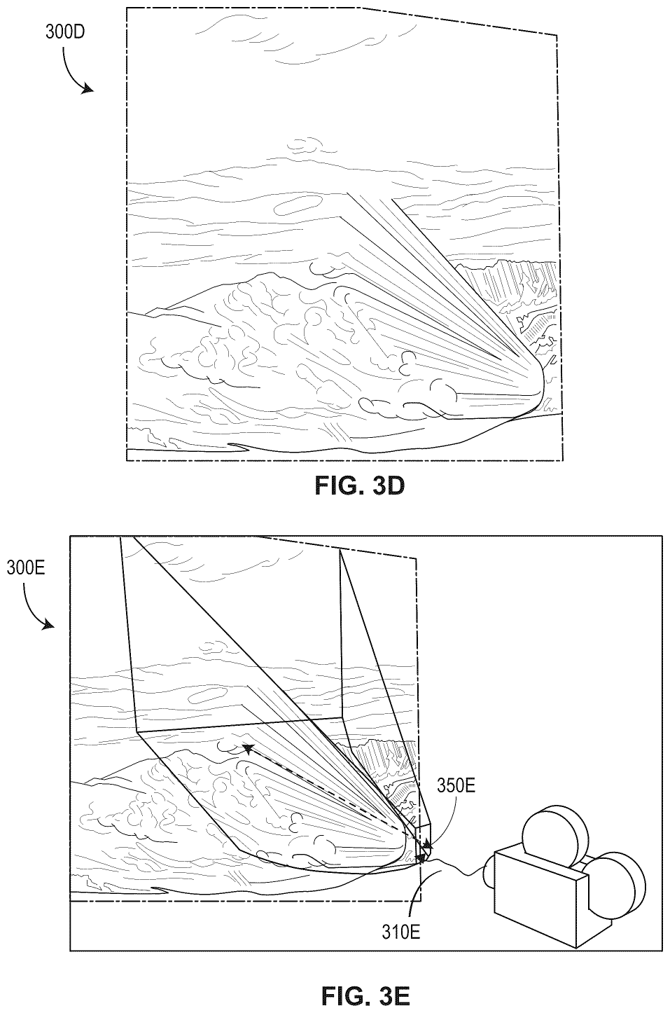

Generally, the 3D conversion module 150 generates a 3D animated image using an input 2D static image. In particular, the 3D conversion module 150 generates, based on the 2D static image, a 3D mesh and a visual perspective trajectory (e.g., using the 3D mesh module 160 and trajectory module 162, respectively) that, when applied in conjunction, cause the 2D static image to appear 3D to a user and to give a sense of motion via the trajectory. The techniques for converting a 2D static image to a 3D animated image using the 3D conversion module 150 are discussed in more detail below with regard to FIGS. 3A-4 and 6.

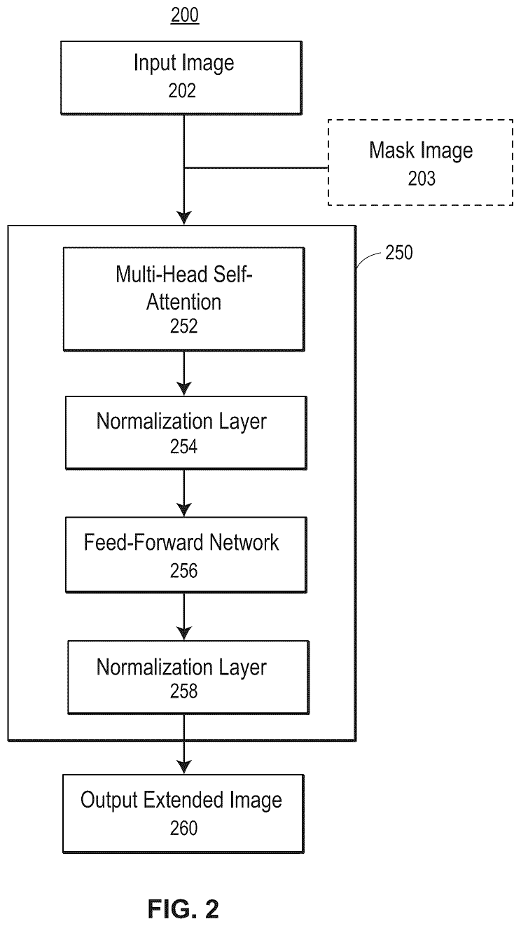

Furthermore, the image processing module 152 performs various operations as pre-processing operations, processing operations, and/or post-processing operations. For example, the threshold module 164 may use one or more models (e.g., trained AI/ML models) to determine whether a 2D static image is a suitable candidate for conversion to a 3D animated image. For example, an image with low quality, too much text, or a logo, and/or an image that lacks depth information such as a cartoon, may make for a poor candidate for a 3D animated image, and thus the threshold module 164 may discard the image responsive to determining that such an image falls below the threshold(s) for the relevant characteristic(s). Similarly, the expansion module 166 may expand a 2D static image using a generative model as described below with regard to FIGS. 2 and 5A-6.

In some implementations in which the 3D animated image is stored as an AVIF image format, the threshold module 164 may additionally or alternatively determine whether the client device 102 supports the AVIF format. In some implementations, the threshold module 164 may determine whether the client device 102 supports the AVIF format based on the browser version, browser type, client device type, and/or other factor(s). If the client device 102 does not support the AVIF format, the computing system 104 may determine to not generate and/or transmit animated 3D images for the client device 102 and/or generate the animated 3D images in a second format (e.g., as a GIF). Similarly, the computing system 104 may determine to use a static image (e.g., from the image registration service 106). In further implementations, the client device 102 may make such a determination after receiving a content response from the computing system 104. Similarly, another computing device (e.g., comparison server 186) and/or the client device 102 may make the determination at serving time.

In some implementations and/or scenarios, the computing system 104 (or another computing system not shown in FIG. 1A) trains a machine learning model 170 using the techniques as described herein. For example, the machine learning model 170 may be a generative model configured to realistically extend an image, a neural network (e.g., a convolutional neural network, recurrent neural network, modular neural network, feed forward neural network, etc.) configured to perform various steps in converting 2D static images to 3D animated images, a model to perform pre-processing and filtering of the 2D static images, and/or any other such model(s) to perform the steps as described herein, as seen below and with regard to FIG. 2.

In particular, the training module 154 may train the AI and/or ML model 170 (e.g., including a generative model and/or a neural network) using training data 168 as described herein. In some implementations, the training data is or includes data (e.g., historical data in a historical data database (not shown)) associated with past 2D static image to 3D animated image conversions. In further implementations, the training data is or includes data (e.g., artificially generated historical data) provided by the publisher.

In some implementations, training machine learning models (e.g., a neural network) may produce byproduct weights, or parameters which may be initialized to random values. The weights may be modified as the network is iteratively trained, by using one of several gradient descent algorithms, to reduce loss and to cause the values output by the network to converge to expected, or “learned”, values. In some implementations, a regression neural network may be selected which lacks an activation function, wherein input data may be normalized by mean centering, to determine loss and quantify the accuracy of outputs. Such normalization may use a mean squared error loss function and mean absolute error. The artificial neural network model may be validated and cross-validated using standard techniques such as hold-out, K-fold, etc. In some implementations, multiple artificial neural networks may be separately trained and operated, and/or separately trained and operated in conjunction.

In some implementations, the machine learning model 170 may include an artificial neural network having an input layer, one or more hidden layers, and an output layer. Each of the layers in the artificial neural network may include an arbitrary number of neurons. The plurality of layers may chain neurons together linearly and may pass output from one neuron to the next, or may be networked together such that the neurons communicate input and output in a non-linear way. In general, it should be understood that many configurations and/or connections of artificial neural networks are possible. For example, the input layer may correspond to input parameters that are given as full images, or that are separated according to pixel sequence size (e.g., fixed width) limits. The input layer may correspond to a large number of input parameters (e.g., one million inputs), in some implementations, and may be analyzed serially or in parallel. Further, various neurons and/or neuron connections within the artificial neural network may be initialized with any number of weights and/or other training parameters. Each of the neurons in the hidden layers may analyze one or more of the input parameters from the input layer, and/or one or more outputs from a previous one or more of the hidden layers, to generate a decision or other output. The output layer may include one or more outputs, each indicating a prediction. In some implementations and/or scenarios, the output layer includes only a single output.

In some implementations, the machine learning model 170 is a generative model. The generative model may have been trained by computing system 104 or another computing system using supervised or semi-supervised learning, and with training data of the appropriate modality (e.g., image data). The generative model may be a general-purpose model (e.g., trained on a wide array of publicly available datasets such as web pages, documents, etc., available via the Internet) or may be a domain-specific model (e.g., trained on custom and/or proprietary datasets, such as documents/data available via one or more intranets). In some implementations, the machine learning model 170 is a model with parameters tuned, via the training process, specifically for high performance in the context of generating images having one or more particular qualities and/or characteristics. In the digital advertising context, for example, the machine learning model 170 may be trained/tuned to generate 3D animated images with emphasis on objects and characteristics that users generally find to be appealing, or that generally grab users' attention (e.g., are salient). Training of this sort may include the use of human-generated input to train and/or refine the machine learning model 170, such as human reviews of the emphasis on objects in images generated by the machine learning model 170.

In some implementations, the computing system 104 accesses a remote server/system that provides generative AI as a service (i.e., with at least a portion of the 3D conversion module 150 and/or image processing module 152 residing at a location remote from the computing system 104). In other implementations, the machine learning model 170 is local to the computing system 104 (i.e., with the 3D conversion module 150 and/or image processing module 152 residing at the computing system 104). Thus, the machine learning model 170 may reside at the computing system 104 as shown in FIG. 1A, or the computing system 104 may access the machine learning model 170 by communicating with another computing system via the network 110. For example, the machine learning model 170 may be an AI and/or ML model that a remote server makes available to computing systems (including computing system 104) via an application programming interface (API).

The training data 168 may generally include any image data used for training purposes. The training data 168, for example, may include labeled or unlabeled image data, historical data for past image conversions, extensions, filtering, and/or other operations as described herein.

In some implementations, the image registration service 106 may provide data (e.g., to or from an image database 108, the computing system 104, or client device 102) that is associated with a particular publisher or content sponsor. The information may therefore include, for example, information in a web page associated with the publisher, such as a web page that the publisher will use as a landing page for an advertisement that includes the 3D animated image data being generated (i.e., a landing page to be presented in response to user selection of the advertisement/3D animated image). As another example, the information may include metadata and/or audience information provided by the publisher (e.g., audience demographics, audience interests, etc.).

The image registration service 106 may additionally provide information associated with the user of the client device 102. The information may include, for example, a search query (text string) entered by the user of the client device 102 in a search engine application or a web page hosted by a search engine server. As another example, the information may include a location of the user of the client device 102 (e.g., a global positioning system (GPS) location of the client device 102, if the user has previously agreed to share a present or past location for use by an entity associated with the computing system 104). In still other examples, the information may include an indication of other content previously viewed by the user (e.g., a category or name of previously viewed image or video content), a profile of the user of the client device 102 (e.g., the user's age, gender, etc., if the user agreed to the use of such information), and/or one or more preferences of the user (e.g., categories for which the user has a preference or affinity, if the user agreed to the use of such information).

The operation of the 3D conversion module 150, the image processing module 152, the training module 154, and their constituent parts, will be discussed in further detail below in connection with various example implementations.

In some implementations, the computing system 104 includes and/or is communicatively coupled with a database (not shown) for storing training data 168, historical data (not shown), and/or other relevant forms of data. Depending on the implementation, each of the databases (e.g., image database 108 and/or databases for the training data 168, historical data, etc.) may be stored in a local memory (e.g., the memory 144), or may be stored in memory remote from the coupled device/system.

In some implementations, publishers hold accounts related to the services provided by the computing system 104. For example, the publishers may create such accounts in order to monetize information resources that they publish or otherwise make available (e.g., by selling advertising in content slots on the publishers' hosted web pages). In these implementations, information associated with the publisher accounts may be stored in an account database (not shown in FIG. 1A). The account database may be stored in the memory 144 or may be stored in one or more memories that are remote from the computing system 104, for example. The account information may include information such as entity name, subscription level, entity preferences (e.g., brand control preferences), and so on. In some implementations, the account information includes selection parameters (e.g., bid amounts or maximum bid amounts) associated with different content sponsors, for use by the computing system 104 or a different computing system in selecting content for inclusion in content slots of publishers' information resources. Depending on the implementation, the computing system 104 may utilize account information (e.g., one or more constraints as noted above) at different times depending on the implementation. For example, content provider account information may be utilized when generating the 3D animated image(s), while publisher account information may be utilized when serving the 3D animated image(s) (e.g., responsive to a request or indication from the client device 102).

FIG. 1B illustrates an exemplary system 100B for generating 3D animated images and an exemplary system 180 for serving 3D animated images to a user device. In particular, the exemplary system 100B may be or include elements of system 100A, such as the image registration service 106, computing system 104, and/or image database 108. In further implementations, additional, fewer, or alternate elements may be present.

In some implementations, the image registration service 106 may include the image database 108 (e.g., as described above with regard to FIG. 1A), as well as a storage table 116. Depending on the implementation, the storage table 116 may be part of the image database 108 and/or separate from the image registration database 118. In some implementations, the storage table 116 may store one or more links or URLs that are associated with one or more 2D static images and/or 3D animated images 188 stored at the image registration database 118. In further implementations, the event module 112 (e.g., part of the image registration service 106) may listen for events to occur and, upon detecting an event (e.g., a user uploading a new image) may trigger the generation process as described herein. In further implementations, the image registration service 106 and/or the event module 112 triggers the computing system 104 to run an algorithm (as described below) to generate the 3D animated image 188. Depending on the implementation, the image registration database 118 may be the image database 108 and/or may include the image database 108. In further implementations, the image registration database includes metadata for one or more 3D animated images and/or 2D static images.

After a 3D animated image is generated, an indexing module 182 may communicate with the image registration service 106 (e.g., via and/or to the image registration database 118) to index one or more 3D animated images to be served to a client device 102. For example, the indexing module 182 may determine to gather one or more 3D animated images responsive to an indication from the distribution server 184 and/or based on stored metadata at the image registration database 118. In some implementations, the comparison module 186 compares a 3D animated image 188 with one or more other image enhancement options. For example, the comparison module 186 may compare the 3D animated image 188 with a 2D static version of the image, with an extended version of the image, etc. In some embodiments, the comparison module 186 compares the images by using one or more machine learning models to predict user behaviors (e.g., chance of click).

In further implementations, the candidate matching server 190 may then match the candidate 3D animated image with a request for content. For example, the request for content may be a request for an ad, and the candidate matching server 190 may match the candidate 3D animated image with the request via an ad auctioning technique. The serving module 192 may then facilitate the rendering of the matched 3D animated image with the rendering module 194 and transmit an indication of the matched 3D animated image to the client device 102. In particular, the rendering module 194 may update a content slot with a link or other indicator of the 3D animated image location at the image registration database 118 and/or storage table 116. The serving module 192 transmits an indication to the client device 102 (e.g., including the link or other location indicator). The client device 102 retrieves the 3D animated image 188 from the storage table 116 using the link or other location indicator from the serving module 192 (e.g., via a front end server, API, or other such module).

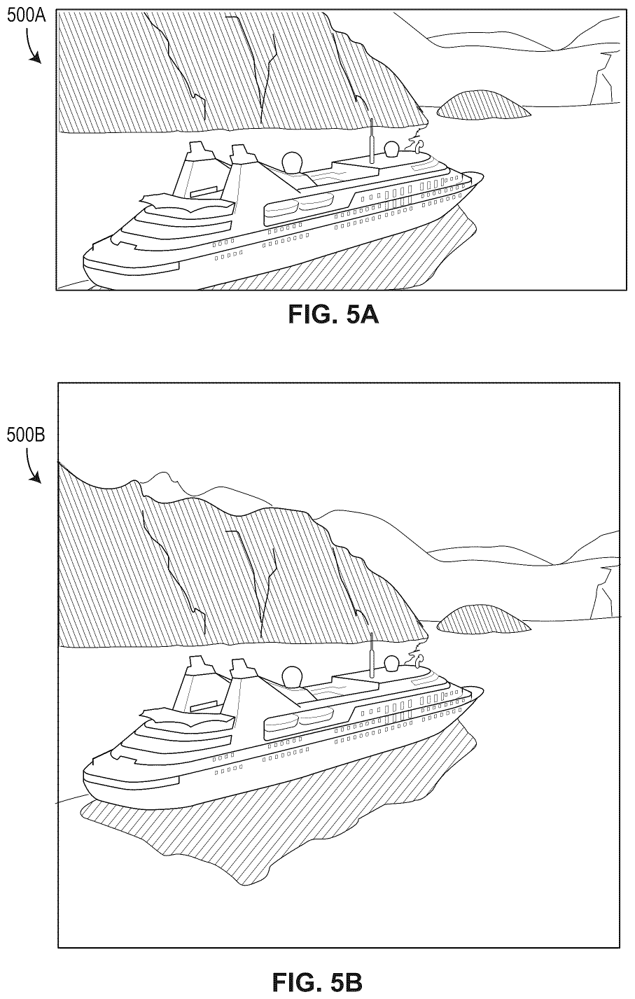

FIG. 2 illustrates an exemplary machine learning model 200 (e.g., including or separate from machine learning model 170) trained as a generative model as described herein. In particular, the model 200 receives an input image 202 and, in some implementations, a mask image 203. The model 200 then outputs an output image 260. In some implementations, the output image 260 is an extended image as described with regard to FIGS. 5A and 5B, below. In some implementations, the input image 202 may be an image indicated by a user as a candidate for generative extension. In further implementations, the input image 202 may be an image determined by a computing system (e.g., computing system 104) as a candidate for generative extension.

Depending on the implementation, the input image 202 may be a baseline image consisting of a first portion and a second portion. In some such implementations, the first portion of the baseline image may be the original image while the second portion may be one or more rows and/or columns of added default pixels (e.g., black or white pixels). In some such implementations, the baseline image is an extended image to fit the same dimensions as the desired extension, and the second portion indicates an area in which the extension is to occur. In some such implementations, the mask image 203 matches the dimensions of the baseline image (e.g., has a same number of columns and rows of pixels) and may indicate which portions of the baseline image are the first portion and the second portion (e.g., with different pixels values).

In some implementations, the model 200 may be based upon a model trained to predict a pixel in a series of pixels. In particular, the model 200 may predict a pixel, row of pixels, column of pixels, etc. that is expected to be a realistic extension of the image. For instance, the model 200 may use the input image 202 and/or mask image 203 to determine a sequence of pixels that would naturally extend from the edges of the image to reach a dimension value for the desired output image. As an example, a picture of a boat in an ocean may extend the bottom with primarily blue pixels to extend the ocean. Similarly, the model 200 may detect part of a reflection in the water and extend the reflection to naturally indicate a reflected boat in the water. More in-depth examples are described herein with regard to FIGS. 5A and 5B.

Advantageously, some implementations use transformers in training the model 200 (e.g., by using a generative pre-trained transformer (GPT) model). More specifically, some implementations use a GPT model that includes (i) an encoder that processes the input sequence, and (ii) a decoder that generates the output sequence. The encoder and decoder may both include a multi-head self-attention mechanism that allows the GPT model to differentially weight parts of the input sequence to infer meaning and context (e.g., using metadata in the historical and/or training data). For example, in the example described above, the GPT model may infer that pixels in a similar but mirror-image pattern, along with an indication of water, means that the similar pixels are part of a reflection and may generate the output sequence accordingly.

The generator training module 250 may include a self-attention block 252 component to attend to different parts of the input simultaneously or near-simultaneously to capture relationships and/or dependencies between the different parts of the input (e.g., referred to as a multi self-attention block, multi-head attention block, multi-head self-attention block, masked multi self-attention block, masked multi-head attention block, masked multi-head self-attention block, etc.). In particular, the self-attention block 252 relates different positions of a series of pixels (e.g., a column, a row, a predetermined area, etc.) to compute a representation of the sequence. As such, the self-attention block 252 may weigh an impact of different pixels in a sequence when sequencing. As such, the model 200 learns to give emphasis to different portions of an input image 202 and/or mask image 203. In some implementations, the model 200 uses metadata related to the input image 202 in place of and/or at the self-attention block 252 to determine impact and/or relationship between pixels within the sequence.

The self-attention block 252 may then compute an attention score representing the impact of each pixel in the sequence with respect to the other pixels in the sequence. The output then proceeds to the normalization layer 254. The normalization layer 254 may normalize the output of the self-attention block 252 (e.g., by applying a softmax function to normalize the scores).

Similarly, the self-attention block may subsequently output into a feed-forward network block 256, which performs a non-linear transformation to generate a new representation of the input and/or relationships between pixels, sequences, etc. In particular, the feed-forward network block 256 may compute a weighted sum of vectors representative of sequences and/or pixels in the input image, using the calculated and normalized attention scores to capture the contextual relationships between pixels. In some implementations, the normalization layer 254 and/or the self-attention block 252 may perform the computation to generate a representation of the relationship between pixels, etc. After the feed-forward network block 256, an additional normalization layer 258 may normalize the respective output and/or add residual connection(s) to allow the output to move directly to another input. The model 200 may therefore learn which parts of an input are important (e.g., remain prevalent through the normalization process). Depending on the implementation, the model 200 may repeat the process for the generator training module 250 1 time, 5 times, 10 times, N times, etc. to train the respective model(s).

Depending on the implementation, an encoder and/or a decoder may be trained as described above. In further implementations, the encoder is trained in accordance with the above, and a decoder includes an additional self-attention block (not shown) receiving the output of the encoder as well.

Furthermore, in some implementations, rather than performing the previous four steps only once, the GPT model iterates the steps and performs them in parallel. At each iteration, new linear projection of the query, key, and value vectors are generated.

Further advantageously, some implementations train and/or tune the model 200 using supervised, unsupervised, and/or semi-supervised techniques. For example, the model 200 may be trained using labels associated with the images to allow the model 200 to recognize the “correct” answer in a pattern for a sequence (e.g., for supervised training). Further, the computing system 104 may train the model 200 using reward techniques, reinforcement techniques, and/or any other such techniques as adapted to the image data described herein.

FIGS. 3A-3E depict an image in various stages of the conversion process from 2D static image to 3D animated image. In particular, FIG. 3A depicts an initial 2D static image 300A. At FIG. 3B, a computing system (e.g., computing system 104) may then generate a depth map 300B based on the initial 2D static image 300A. In particular, the computing system 104 may generate the depth map 300B by using a trained machine learning model (e.g., machine learning model 170) to determine an inverse depth map for the initial 2D static image 300A. For example, the computing system 104 may train a machine learning model (e.g., via training module 154) using data sets including an absolute depth (e.g., from laser-based measurements or stereo cameras with known calibration), depth up to an arbitrary scale (e.g., from structure-from-motion data sets), disparity maps (from stereo cameras with unknown calibration), etc. Depending on the implementation, such data sets may be mixed or general image data sets that include static images with depth annotations. As such, the machine learning model may be trained via supervised machine learning, semi-supervised machine learning, unsupervised machine learning, etc. as described herein.

The computing system 104 may determine the disparity and depth map for a particular static image 300A by feeding the static image 300A into the trained machine learning model. The computing system 104 may then generate the depth map 300B such that the depth map 300B is representative of the determined disparity and/or depth map. Depending on the implementation, the computing system 104 may supplement the disparity and/or depth map determination using image analysis and/or recognition techniques (e.g., optical character recognition (OCR), color contrast, pixel analysis, etc.).

At FIG. 3C, the computing system 104 may then generate a 3D mesh 300C based on the depth map 300B. In particular, the computing system 104 may calculate and determine a distance for the various portions of the depth map 300B using the trained machine learning model as described above. In further implementations, the computing system 104 may determine a distance for the various portions of the depth map using supplemental or replacement image analysis and/or recognition techniques (e.g., optical character recognition (OCR), color contrast, pixel analysis, etc.). The computing system 104 may then stretch the depth map 300B such that the portions of the depth map 300B are aligned with the determined depths while remaining a continuous image. In some such implementations, the 3D mesh 300C is comprised of a mesh of multiple heat zones, each zone depicting a particular region of the depth map 300B. In the exemplary implementation depicted in FIG. 3C, the heat zones are right triangles, arranged to form a grid of squares. In further implementations, the heat zones are individual pixels, smaller collections of pixels, identified objects, repeating shapes, and/or any other such output of a method for delineating such zones.

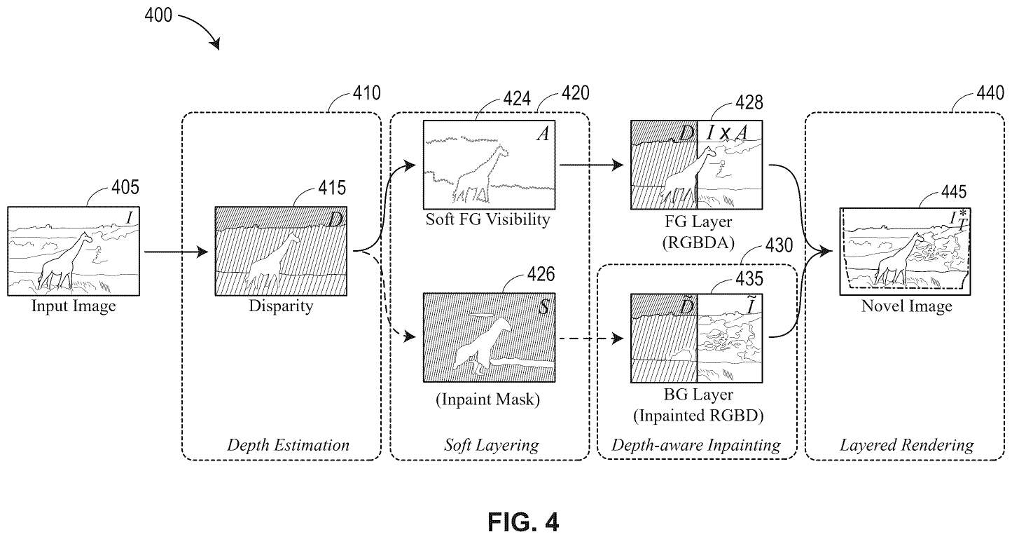

At FIG. 3D, the computing system 104 overlays the 3D mesh 300C with the initial 2D static image 300A to generate a 3D stretched image 300D. In some implementations, the computing system 104 uses an inpainting model as described with regard to FIG. 4 below to predict and generate new portions of the 3D stretched image 300D. For example, the computing system 104 may generate portions of the image connecting the portions of the 3D stretched image 300D with different depths to minimize distortions visible to a viewer.

At FIG. 3E, the computing system 104 determines a visual perspective trajectory 310E in the 3D image 300E based on the 3D stretched image 300D. The visual perspective trajectory 310E is representative of a simulated camera path and, as such, provides an illusion of movement to a viewer. In some implementations, the computing system 104 determines the visual perspective trajectory 310E such that the visual perspective trajectory 310E follows at least partially along an axis 350E associated with the depth of the 3D image 300E (although in some implementations, the computing system 104 determines the visual perspective trajectory 310E without explicitly determining, calculating, or using the axis 350E). Depending on the implementation, the computing system 104 may determine multiple visual perspective trajectories and may score each of the different visual perspective trajectories based on one or more metrics. In various implementations, the metrics may include a view of the salient objects (e.g., the more salient objects in the visual perspective trajectory 310E, the higher the score), view of the inpainted portions of the image (e.g., the more inpainted portions of the image in the visual perspective trajectory 310E, the lower the score), adherence to the axis 350E associated with depth (e.g., the better adherence of the visual perspective trajectory 310E, the higher the score), etc. The computing system 104 may then select the visual perspective trajectory 310E as the trajectory with the highest score. In some implementations, the computing system 104 selects the visual perspective trajectory 310E prior to performing inpainting, and inpaints only portions that will be seen in the visual perspective trajectory 310E.

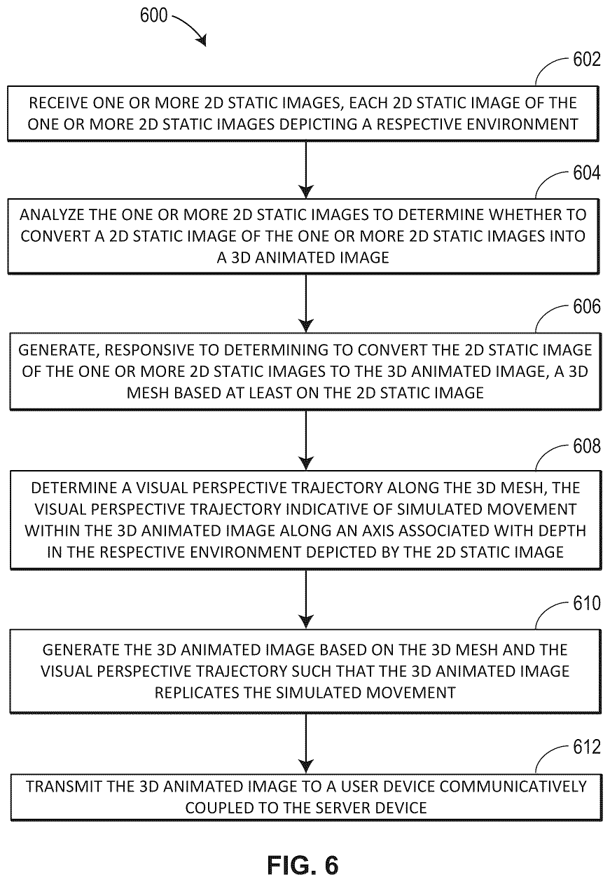

FIG. 4 is a diagram of an example process 400 for converting a 2D static image into a 3D animated image (e.g., as described with regard to FIGS. 3A-3E and 6). Depending on the implementation, the example process 400 may be a series of modules implemented by a computing system (e.g., 3D conversion module 150 of computing system 104 of FIG. 1A). In further implementations, the process 400 may be or include a plurality of devices, each implementing one or more of the modules as described herein.

In some implementations, the process 400 performed by a computing system (e.g., computing system 104 and/or any other such computing system as described herein) includes a depth estimation stage 410, a soft layering stage 420, an inpainting stage 430, and a layered rendering stage 440. It will be understood that the process 400 may include additional, fewer, and/or alternate stages as described herein. To begin a conversion for the process 400, the computing system 104 may receive an input image 405 (e.g., a 2D static image such as 2D static image 300A) I∈R^{n×3}, with n pixels at a depth estimation stage 410. At the depth estimation stage 410, the computing system 104 then estimates a depth for the image D∈Rⁿ (e.g., using a trained machine learning model as described above with regard to FIG. 3B). The computing system 100A then, at the soft layering stage 420, decomposes the scene in the input image 405 into two layers by estimating foreground pixel visibility map A∈Rⁿ and inpainting mask S∈Rⁿ. The computing system 104 then constructs a foreground Red Green Blue-Depth-Alpha (RGBDA) layer with the input image I (e.g., input image 405), the corresponding disparity D, and the pixel visibility map A. The computing system 104 additionally constructs a background Red Green Blue-Depth (RGBD) layer with the inpainted RGB image Ĩ and the inpainted disparity map \tilde{D} (e.g., at the inpainting stage 430). The computing system 104 then, at the layered rendering stage 440, constructs triangle meshes from the two disparity maps, textured with I and A for the foreground and Ĩ for the background; renders each into a target viewpoint; and composites the foreground rendering over the background rendering.

In particular, at the depth estimation stage 410, the computing system 104 receives an input image 405 (e.g., an RGB image I∈R^{n×3} with n pixels and estimates a disparity map 415 (e.g., disparity map D∈R^{n×1} depicting an inverse depth map). In some implementations, the computing system 104 uses a trained convolutional neural network (CNN) to estimate the disparity map 415. In some such implementations, the CNN is trained on training data to achieve zero-shot cross dataset transfer, as described above with regard to FIG. 3B. As such, the CNN utilizes a principled dataset mixing strategy and a robust scale and shift invariant loss function that results in predicted disparity maps up to an arbitrary scale and shift factor. The disparity map 415 as an output of the CNN may be a normalized disparity map D∈[0,1]ⁿ, which is then used in the subsequent parts of process 400. In some implementations, the computing system 104 performs, at the depth estimation stage 410 and/or another stage of process 400, Gaussian blur and max-pool operations on the disparity map 415 to reduce missing foreground pixels and noise in layering at other stages (e.g., soft layering stage 420).

The computing system 104 then, at the soft layering stage 420, generates a visibility map 424 of the foreground layer and a soft disocclusion map 426 for background RGBD inpainting. In particular, the computing system 104 generates the visibility map 424 by estimating visibility at each image pixel, which enables a viewer to see through to the background layer when rendering novel-view images. In particular, the computing system 104 renders the disparity map 415 as a textured mesh (e.g., a triangle mesh) into a new viewpoint. The computing system 104 addresses stretching artifacts that appear at depth discontinuities by constructing a visibility map 424 (e.g., soft pixel visibility map A) that has lower values (e.g., higher transparency) at depth discontinuities. As such, the visibility map 424 depicts lower visibility in proportion to changes in disparity, leading to greater transparency at the discontinuities through to the background layer. In particular, for an estimated disparity map D for input image I, the pixel visibility map A∈[0,1]ⁿ is A=e^{-β∥∇D∥}^{²}, where ∇ is the Sobel gradient operator and β∈R is a scalar parameter. As such, the pixel visibility varies inversely with disparity gradient magnitude. In some implementations, low foreground visibility (A≈0) corresponds to high foreground pixel transparency.

Further at the soft layering stage 420, the computing system 104 may additionally construct a soft disocclusion map 426 as a mask to guide inpainting in the background layer and/or perform training of a model to perform inpainting in the background layer. In particular, the computing system 104 paints and/or trains a model to paint pixels that have potential to be disoccluded when the visual trajectory perspective moves. The computing system 104 generates the soft disocclusion map 426 based on the disparity map 415. For example, a background region at a pixel location (x, y) has potential to be disoccluded by the foreground if there exists a neighborhood pixel (xᵢ, yⱼ) with a disparity difference with respect to the foreground pixel at (x, y) that is greater than the distance between the pixel locations. In some implementations, a background pixel is more likely to be disoccluded if the foreground disparity at the point is higher compared to that of surrounding regions. In some implementations, the computing system 104 is constrained to a fixed neighborhood of m pixels around each pixel in calculating the disparity difference. In further implementations, the computing system 104 is further constrained to the same row and column as the pixel (e.g., within m pixels up, down, left, or right of the pixel).

The computing system 400 then generates the foreground layer 428 (e.g., as a combination of the input image 405 and the visibility map 424) and background layer 435 (e.g., at the inpainting stage 430). In particular, in some implementations, the computing system 104, at the inpainting stage 430, inpaints the disoccluded regions using RGBD techniques and incorporates the result into the background layer 435. In some implementations, the computing system 104 and/or a machine learning model stored at the computing system 104 (e.g., machine learning model 170) learns to neglect the regions in front of each pixel to be inpainted to avoid inpainting the foreground. In further implementations, the computing system 104 uses the soft disocclusion map 426 as an inpainting mask (e.g., during training and/or when generating the output image). In some such implementations, training a model (e.g., machine learning model 170 or another such model) for the inpainting stage 430 using such inpainting masks improves overall depth-awareness in the model. In further implementations, the model additionally is trained on traditional stroke-shape inpainting masks to improve learning for inpainting of thin or small objects. As such, a single image dataset can be adapted to be used without requiring additional annotations. In some implementations, the computing system 104 uses a patch-based discriminator D to discriminate between real and generated results and applies an adversarial loss model to the inpainting network. In some such implementations, the objective loss for the inpainting network is a weighted sum of the reconstruction loss (e.g., the distance between inpainted results and ground truth) and the hinge adversarial loss.

After generating the foreground layer 428 and the background layer 435, the computing system 104 generates the output view 445 (e.g., at the layered rendering stage 440). In some implementations, the computing system 104, at the layered rendering stage 440, composites together the foreground layer 428 and the background layer 435. In particular, the foreground layer 428 comprises the input image I (e.g., input image 405), visibility map A (e.g. visibility map 424), and disparity D (e.g., disparity map 415). The computing system 104 back-projects the disparity map 415 to recover a 3D point per pixel and connects points that neighbor each other on the 2D pixel grid to construct a mesh (e.g., the 3D mesh 300C). The computing system 104 then textures the mesh with the input image 405 and the visibility map 424 to generate a foreground output view (not shown). In some implementations, the visibility map 424 is resampled but not used for compositing while rendering. The foreground output view is given by a rigid transformation T from the canonical viewpoint, and the result of the rendering is a new foreground RGB image I_{T} and visibility map A_{T}.

The background layer 435 includes a background image Ĩ and disparity \tilde{D}. The layered rendering stage 440 similarly generates a mesh (e.g., 3D mesh 300C) from \tilde{D}, textures the mesh with Ĩ, and projects the mesh into the view to generate a background output view (not shown) with new background image Ĩ_{T}. The computing system 104, at the layered rendering stage 440, then composites the foreground over the background to generate the output view 445 as I*_{T}=A_{T}I_{T}+ (1−A_{T})Ĩ_{T}.

FIGS. 5A and 5B illustrate an exemplary original image 500A and an extended image 500B, extended using the techniques as described herein (e.g., with regard to FIG. 2 above). In the exemplary implementations of FIGS. 5A and 5B, the original image 500A includes most of a boat with a background of cliffs and part of a skyline. The extended image 500B, then, extends the image upwards and downwards, completing the cutoff portion of the bottom of the boat, finishing the cliffs at a natural height given the skyline, and extending the water down, including a continuation of the reflection of the boat. Depending on the implementation, a computing system (e.g., computing system 104) may use a generative machine learning model (e.g., machine learning model 170 or model 200) to generate additional pixels that predict a realistic extension of the image, even if not actually accurate to the real-life scene. Depending on the implementation, the computing system 104 may use the extended image 500B as a 2D static image for conversion rather than the original image 500A. In further implementations, the computing system 104 may extend the original image 500A as part of the conversion process.

FIG. 6 is a flow diagram of an example method 600 for converting a 2D static image into a 3D animated image. The method 600 may be implemented as instructions stored on one or more computer-readable media and executed by one or more processors in one or more computing devices. For example, the method 600 may be implemented by the processor 142 of the computing system 104 in FIG. 1A, when executing instructions of the 3D conversion module 150, image processing module 152, and/or any other such module as described herein. As a further example, the method 600 may be implemented by one or more processors of a computing device communicatively coupled to the computing system 104. It will be understood that any such implementation is exemplary, and that additional, fewer, and/or alternate components may be used to implement the example method 600.

At block 602 of the method 600, the computing system 104 receives one or more 2D static images, each 2D static image of the one or more 2D static images depicting a respective environment. In some implementations, the computing system 104 receives multiple 2D static images and determines a single 2D static image of the group to convert to a 3D animated image. In some implementations, the computing system 104 determines which 2D static image to convert as being the highest quality image, having the least text, having a preferred ratio of salient object and/or foreground size to background size, etc. In further implementations, the computing system 104 detects a 2D static image as being a higher quality version of a 2D static image already converted into a 3D animated image. Depending on the implementation, the computing system 104 may automatically convert the higher quality image and discard the lower quality 3D animated image, convert and keep both, provide a warning to a user that the image has already been converted, etc.

At block 604, the computing system 104 analyzes the one or more 2D static images to determine whether to convert a 2D static image of the one or more 2D static images into a 3D animated image. In some implementations, the computing system 104 determines whether to convert the 2D static image based on one or more respective characteristics of the 2D static image(s). Depending on the implementation, the one or more respective characteristics may include a quality metric, a text quantity metric, a logo indicator, a depth metric, and/or any other such similar characteristic. As such, the computing system 104 may make the determination to convert the 2D static image into a 3D animated image based on whether the 2D static image is low quality (e.g., has a quality metric below a predetermined threshold), has too much text (e.g., has a text quantity metric above a predetermined threshold), includes a logo (e.g., has a positive logo indicator), is a cartoon (e.g., has a depth metric below a predetermined threshold), etc. Depending on the implementation, the computing system 104 may filter out the 2D static images based on the characteristics and discard the images, transmit the 2D static images to another computing system 104 and/or module stored on computing system 104 for serving as 2D static media, transmit an error to a user to indicate to try another image (e.g., including the reason for the determination), etc.

In some implementations, the computing system 104 generates one or more predicted realistic extensions of the 2D static image, as described above with regard to FIGS. 5A and 5B. In some such implementations, blocks 606-612 are based on the extended 2D static image (e.g., including the original 2D static image and the generated predicted realistic extensions of the 2D static image) rather than the original 2D static image alone.

At block 606, the computing system 104 generates a 3D mesh based at least on the 2D static image. In implementations in which the computing system performs block 604, the computing system 104 may generate the 3D mesh responsive to determining to convert the particular 2D static image to a 3D animated image. In some implementations, the computing system 104 estimates a depth map representative of perceived depths associated with the 2D static image and generates the 3D mesh based on the 2D static image (e.g., as depicted in FIGS. 3B and 3C above). In some such implementations, the computing system 104 estimates the depth map using a trained depth estimation model (e.g., machine learning model 170), as described herein.

At block 608, the computing system 104 determines a visual perspective trajectory along the 3D mesh. In some implementations, the visual perspective trajectory is indicative of simulated movement within the 3D animated image at least partially along an axis associated with depth in the respective environment depicted by the 2D static image. In further implementations, the computing system 104 determines the visual perspective trajectory based on one or more salient (e.g., important, eye-catching, centralized, etc.) objects in the respective environment of the 2D static image.

At block 610, the computing system 104 generates a 3D animated image based on the 3D mesh and the visual perspective trajectory such that the 3D animated image replicates the simulated movement. In some implementations, the computing system 104 generates the 3D animated image by overlaying the 2D static image and the 3D mesh to generate a 3D depth overlay. The computing system 104 then reconstructs one or more missing or stretched regions in the 3D depth overlay. In further implementations, the computing system 104 includes a moving viewpoint in the generated 3D animated image in accordance with the determined visual perspective trajectory. In particular, the computing system 104 may zoom at least partially along an axis associated with depth in accordance with the visual perspective trajectory to give an illusion of movement into the scene.

Depending on the implementation, the computing system 104 generates the 3D animated image such that the 3D animated image is displayed as a portrait format image (e.g., with an aspect ratio of 9×16). In some implementations, the computing system 104 extends the 3D animated image or the 2D static image prior to conversion to fit the portrait format. In further implementations, the computing system 104 generates the visual perspective trajectory and/or 3D animated image such that salient objects (e.g., objects determined to be important to the 3D animated image) are prioritized to be completely or mostly in frame.

At block 612, the computing system 104 transmits the 3D animated image to a user device communicatively coupled to the computing system 104 (e.g., client device 102). In some implementations, prior to transmitting the 3D animated image to the client device 102, the computing system 104 transmits the 3D animated image and/or a subset of 3D animated images to another computing device and/or reviews the 3D animated image and/or subset of 3D animated images. In some such implementations, the computing system 104 and/or the computing device automatically filters out any 3D animated images that are low quality, have more than a predetermined threshold of artifact occurrences, fail to meet one or more characteristic thresholds (e.g., such as those described for filtering 2D static images above), and/or otherwise are not to be displayed to a client device 102. In further implementations, a user manually reviews at least some of the 3D animated images before approving a batch. In still other implementations, the computing system 104 and/or computing device remove one or more 3D animated images from a serving stack and/or order based on user feedback from users to whom the 3D animated images are displayed (e.g., via a report option, user bug report, user feedback option, etc.).

In further implementations, the computing system 104 transmits the 3D animated image(s) to a user device using various content serving techniques. For example, the computing system 104 may transmit one or more 3D animated images to be displayed in one or more content slots at a client device 102 responsive to a request from the client device 102 for content. In some such implementations, a content serving platform (e.g., image registration service 106) regulates requests and/or responses between the client device 102 and the computing system 104. In some implementations, the image registration service 106 and/or computing system 104 transmits the 3D animated images to the client device 102 such that the client device 102 displays the 3D animated image(s) according to one or more predetermined image serving templates.

In still further implementations, the computing system 104 determines that a user deletes a 2D static image. Depending on the implementation, the computing system 104 keeps the 3D animated image conversion, deletes the 3D animated image conversion, or requests instructions from the user. In still further implementations, the computing system 104 ranks performance of the 3D animated image(s) against other 3D animated images, 2D static images, and the original 2D static image to determine whether to serve the 3D animated images. Depending on the implementation, the computing system 104 may rank the 3D animated images based on subjective metrics (e.g., user experience surveys, user reports, etc.) and/or objective metrics (e.g., number of users to interact with the 3D animated images, number of users to view the entire 3D animated image, number of users to perform a search associated with the 3D animated images, etc.).

Artificial intelligence (AI) is a segment of computer science that focuses on the creation of models that can perform tasks with little to no human intervention. Artificial intelligence systems can utilize, for example, machine learning and computer vision. Machine learning, and its subsets, such as deep learning, focus on developing models that can infer outputs from data. The outputs can include, for example, predictions and/or classifications. Computer vision focuses on analyzing and interpreting images and videos. Artificial intelligence systems can include generative models that generate new content in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data and may be further updated or refined during their use based on additional feedback/inputs.

In some implementations, the computing system 104 may use one or more the machine learning models noted above to perform any one or more of the operations discussed herein in connection with machine learning.

Although the foregoing text sets forth a detailed description of numerous different aspects and implementations of the invention, it should be understood that the scope of the patent is defined by the words of the claims set forth at the end of this patent. The detailed description is to be construed as exemplary only.

The following additional considerations apply to the foregoing discussion.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present) and B is true (or present), and both A and B are true (or present).

Upon reading this disclosure, those of skill in the art will appreciate still additional alternative structural and functional designs through the principles described herein. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

What is claimed is:

1. A computer-implemented method for converting two-dimensional (2D) static images to three-dimensional (3D) animated images, the computer-implemented method comprising:
receiving, by one or more processors of a server device, one or more 2D static images, each 2D static image of the one or more 2D static images depicting a respective environment;
generating, by the one or more processors, a 3D mesh based on a 2D static image of the one or more 2D static images;
determining, by the one or more processors, a visual perspective trajectory along the 3D mesh, the visual perspective trajectory indicative of simulated movement within a 3D animated image at least partially along an axis associated with depth in the respective environment depicted by the 2D static image; and
generating, by the one or more processors, the 3D animated image based on the 3D mesh and the visual perspective trajectory such that the 3D animated image replicates the simulated movement.

2. The computer-implemented method of claim 1, further comprising:
analyzing, by the one or more processors, the one or more 2D static images to determine, based on one or more respective characteristics of the one or more 2D static images, whether to convert the 2D static image into the 3D animated image;
wherein the generating the 3D mesh is responsive to determining to convert the 2D static image into the 3D animated image.

3. The computer-implemented method of claim 2, wherein the one or more respective characteristics of the one or more 2D static images include one or more respective quality metrics of the one or more 2D static images, and the analyzing the one or more 2D static images includes:
determining, by the one or more processors, a respective quality metric for each of the one or more 2D static images using a trained image quality model; and
filtering, by the one or more processors, the one or more 2D static images to discard 2D static images associated with respective quality metrics below a predetermined quality threshold.

4. The computer-implemented method of claim 2, wherein the one or more respective characteristics of the one or more 2D static images include one or more respective text quantity metrics of the one or more 2D static images, and the analyzing the one or more 2D static images includes:
determining, by the one or more processors, a respective text quantity metric for each of the one or more 2D static images using an optical character recognition (OCR) model; and
filtering, by the one or more processors, the one or more 2D static images to discard 2D static images associated with respective text quantity metrics below a predetermined text quantity threshold.

5. The computer-implemented method of claim 2, wherein the one or more respective characteristics of the one or more 2D static images include one or more respective logo indicators of the one or more 2D static images, and the analyzing the one or more 2D static images includes:
determining, by the one or more processors, a logo indicator for each of the one or more 2D static images using a logo detection model; and
filtering, by the one or more processors, the one or more 2D static images to discard 2D static images determined to include a logo.

6. The computer-implemented method of claim 2, wherein the one or more respective characteristics of the one or more 2D static images include one or more respective depth metrics of the one or more 2D static images, and the analyzing the one or more 2D static images includes:
determining, by the one or more processors, a respective depth metric for each of the one or more 2D static images using a depth recognition model; and
filtering, by the one or more processors, the one or more 2D static images to discard 2D static images with depth metrics below a predetermined depth threshold.

7. The computer-implemented method of claim 1, further comprising:
estimating, by the one or more processors and using a trained depth estimation model, a depth map representative of perceived depths associated with the 2D static image;
wherein the generating the 3D mesh is based on the depth map.

8. The computer-implemented method of claim 1, further comprising:
generating, by the one or more processors and using a trained generative neural network, one or more predicted realistic extensions of the 2D static image;
wherein the generating the 3D mesh is further based on the one or more predicted realistic extensions of the 2D static image.

9. The computer-implemented method of claim 1, wherein the generating the 3D animated image includes:
overlaying, by the one or more processors, the 2D static image and the 3D mesh to generate a 3D depth overlay; and
reconstructing, by the one or more processors and using a trained inpainting model, one or more missing or stretched regions in the 3D depth overlay.

10. The computer-implemented method of claim 1, wherein the determining the visual perspective trajectory is based on one or more salient objects in the respective environment of the 2D static image.

11. A computing device configured to convert two-dimensional (2D) static images to three-dimensional (3D) animated images, the computing device comprising:
one or more processors; and
a computer-readable medium storing instructions that, when executed, cause the one or more processors to:
receive one or more 2D static images, each 2D static image of the one or more 2D static images depicting a respective environment;
generate a 3D mesh based on a 2D static image of the one or more 2D static images;
determine a visual perspective trajectory along the 3D mesh, the visual perspective trajectory indicative of simulated movement within a 3D animated image at least partially along an axis associated with depth in the respective environment depicted by the 2D static image; and
generate the 3D animated image based on the 3D mesh and the visual perspective trajectory such that the 3D animated image replicates the simulated movement.

12. The computing device of claim 11, wherein the computer-readable medium further stores instructions that, when executed, cause the one or more processors to:
analyze the one or more 2D static images to determine, based on one or more respective characteristics of the one or more 2D static images, whether to convert the 2D static image into the 3D animated image;
wherein generating the 3D mesh is responsive to determining to convert the 2D static image into the 3D animated image.

13. The computing device of claim 12, wherein the one or more respective characteristics of the one or more 2D static images include one or more respective quality metrics of the one or more 2D static images, and the analyzing the one or more 2D static images includes:
determining a respective quality metric for each of the one or more 2D static images using a trained image quality model; and
filtering the one or more 2D static images to discard 2D static images associated with respective quality metrics below a predetermined quality threshold.

14. The computing device of claim 12, wherein the one or more respective characteristics of the one or more 2D static images include one or more respective text quantity metrics of the one or more 2D static images, and the analyzing the one or more 2D static images includes:
determining a respective text quantity metric for each of the one or more 2D static images using an optical character recognition (OCR) model; and
filtering the one or more 2D static images to discard 2D static images associated with respective text quantity metrics below a predetermined text quantity threshold.

15. The computing device of claim 12, wherein the one or more respective characteristics of the one or more 2D static images include one or more respective logo indicators of the one or more 2D static images, and the analyzing the one or more 2D static images includes:
determining a logo indicator for each of the one or more 2D static images using a logo detection model; and
filtering the one or more 2D static images to discard 2D static images determined to include a logo.

16. The computing device of claim 12, wherein the one or more respective characteristics of the one or more 2D static images include one or more respective depth metrics of the one or more 2D static images, and the analyzing the one or more 2D static images includes:
determining a respective depth metric for each of the one or more 2D static images using a depth recognition model; and
filtering the one or more 2D static images to discard 2D static images with depth metrics below a predetermined depth threshold.

17. The computing device of claim 11, wherein the computer-readable medium further stores instructions that, when executed, cause the one or more processors to:
estimating, by the one or more processors and using a trained depth estimation model, a depth map representative of perceived depths associated with the 2D static image;
wherein generating the 3D mesh is based on the depth map.

18. The computing device of claim 11, wherein the computer-readable medium further stores instructions that, when executed, cause the one or more processors to:
generating, by the one or more processors and using a trained generative neural network, one or more predicted realistic extensions of the 2D static image;
wherein generating the 3D mesh is further based on the one or more predicted realistic extensions of the 2D static image.

19. The computing device of claim 11, wherein generating the 3D animated image includes:
overlaying the 2D static image and the 3D mesh to generate a 3D depth overlay; and
reconstructing, using a trained inpainting model, one or more missing or stretched regions in the 3D depth overlay.

20. The computing device of claim 11, wherein determining the visual perspective trajectory is based on one or more salient objects in the respective environment of the 2D static image.
